(19) United States
(12) Patent Application Publication
(10) Pub. No.: US 2010/0192450 A1
(43) Pub. Date: Aug. 5, 2010

(54) Self Closing Glue Trap

(76) Inventor: Bernardo Beresnitsky, Brooklyn, NY (US)

Correspondence Address: Bernard Malina, Esq.;Malina & Associates, PLLC, 17th Floor, 444 Madison Avenue, New York, NY, 10022, US

(21) Appl. No.: 12/631,154

(22) Filed: Dec. 4, 2009

Related U.S. Application Data
(60) Provisional application No. 61/119,850, filed on Dec. 4, 2008.

(51) Int. Cl. A01M 23/00

(52) U.S. Cl. 43/58

(57) ABSTRACT

A glue trap includes as substrate which has a glue layer deposited on a first surface and score lines formed on a second surface. When a rodent ventures onto the glue layer the action of the rodent in trying to free itself causes the glue trap to roll up and envelop the rodent.

### FIELD OF THE INVENTION

The present invention relates generally to the field of traps for rodent control and more particularly, to a self-closing glue trap.

### BACKGROUND OF THE INVENTION

The prior art related to rodent control includes various examples of glue traps which typically include a trough-like container which contains a layer of non-drying glue. When a rodent ventures onto the layer of glue, the rodent's feet and fur become adhered to the glue layer. The user then disposes of the glue trap with the ensnared rodent.

A key disadvantage of the conventional glue trap is associated with the rodent remaining in full view after it has become ensnared on the glue layer. This is both unsightly and unhygienic.

### OBJECTS AND SUMMARY OF THE INVENTION

It is an object of the invention to provide a self-closing glue trap in which after ensnaring a rodent, the glue trap closes thereby eliminating visual contact with the rodent.

Another object of the invention is to provide a self-closing glue trap which is extremely reliable in operation.

Yet another object of the present invention is to provide a self-closing glue trap which can be manufactured economically in volume resulting in a relatively low unit cost.

Other objects and a fuller understanding of the invention will be provided hereinafter.

In accordance with the present invention, there is provided a self-closing glue trap which includes a glue layer disposed on a substrate. The substrate has a plurality of score lines or hinge lines on the face opposite the glue layer. When the rodent ventures onto the glue layer, the score lines or hinge lines enable the substrate to roll up thus enclosing the rodent.

### BRIEF DESCRIPTION OF THE DRAWINGS

FIG. 1 is a schematic plan view of a self-closing glue trap made according to the present invention;

FIG. 2 is a side elevation view of the self-closing glue trap of FIG. 1 taken along the line 2-2 of FIG. 1;

FIG. 3 is a fragmentary side elevation view similar to FIG. 2 drawn to an enlarged scale;

FIG. 4 is a plan view similar to FIG. 1 showing a first alternative embodiment of the invention;

FIG. 5 is a plan view similar to FIG. 1 showing a second alternative embodiment of the invention; and

FIG. 6 is an end view of the embodiment of FIG. 1 shown in use with a rodent shown ensnared in the glue trap.

### DESCRIPTION OF THE INVENTION

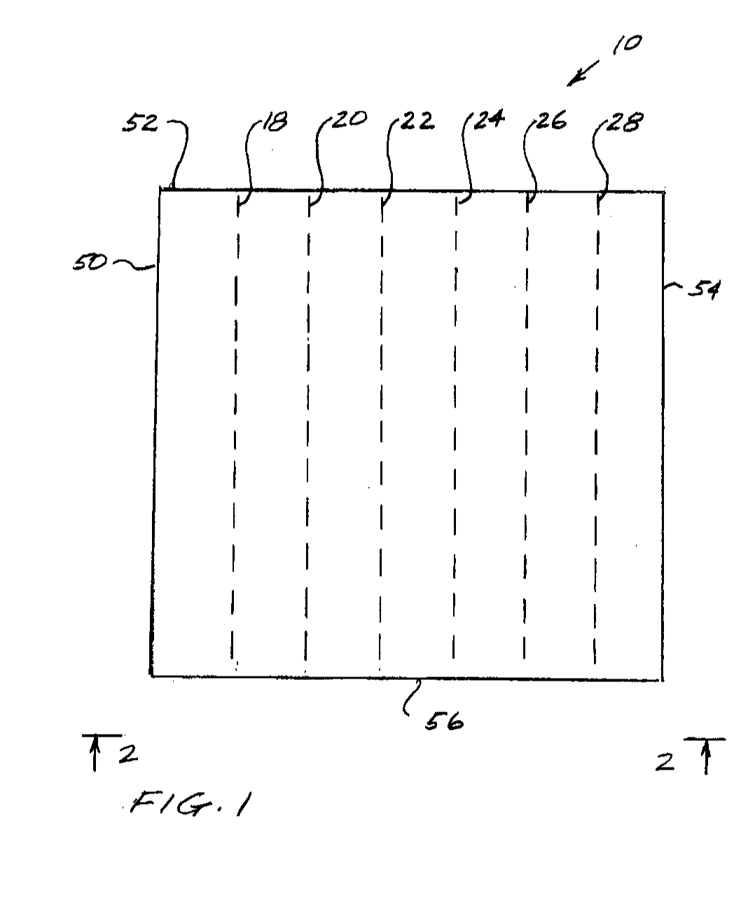

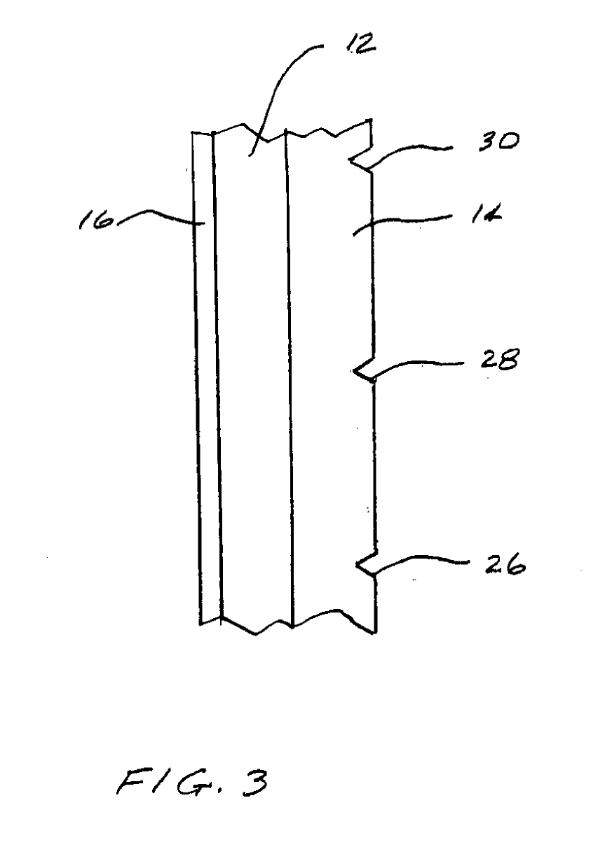

With reference to the drawings, there is shown in FIGS. 1-3 a self-closing glue trap 10 made according to the present invention. The self-closing glue trap 10 includes a non-drying layer of glue 12 which is disposed on a substrate 14.

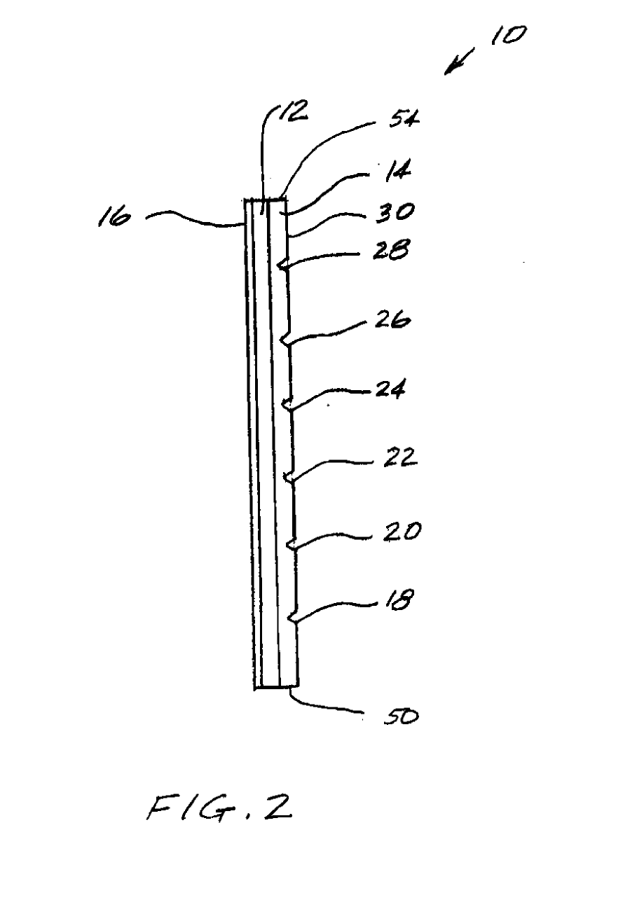

For purposes of storage and shipment, a release layer 16 of paper or plastic covers the layer of glue 12 as is best shown in FIG. 2.

The release layer 16 is removed immediately prior to use.

As indicated schematically by the broken lines 18, 20, 22, 24, 26, 28, the bottom surface 30 of the substrate 14 includes a plurality of score lines or indentations which form a series of hinges.

The substrate 14 is generally flat and may be made of cardboard, paste board or plastic. For cardboard or paste board substrates, the score lines 18, 20, 22, 24, 26, 28 may be formed using a pressing process. For plastic substrates, the indentations may be formed by a pressing or a molding process.

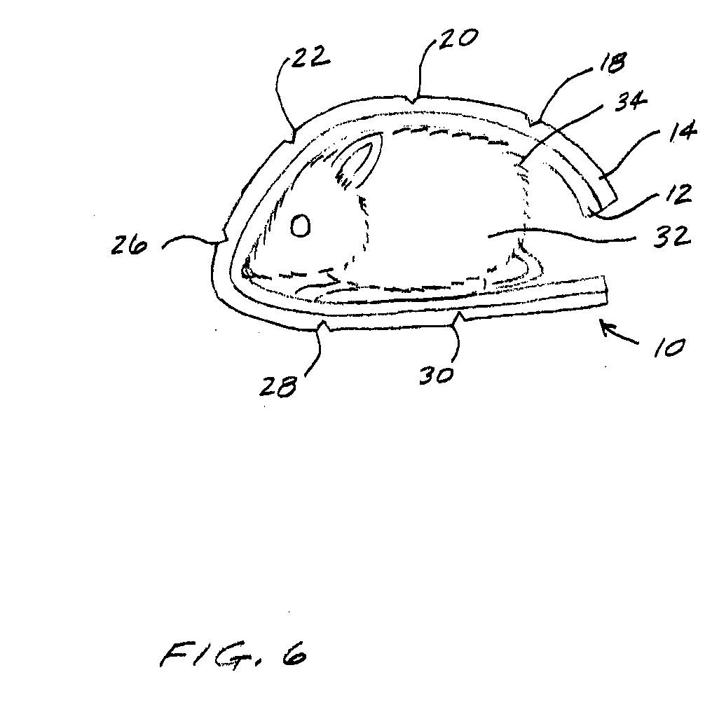

As is shown schematically in FIG. 6, when a rodent 32 steps onto the glue layer 12, the rodent 32 becomes adhered to the glue layer 12. As the rodent 32 moves in an effort to free itself, additional portions of the rodent's fur 34 becomes adhered to the glue layer 12. The glue layer 12 is extremely flexible and provides virtually no resistance to bending. The score lines or indentations 18, 20, 22, 24, 26, 28 act as hinges to make the substrate 14 extremely flexible. As the rodent 32 struggles and rolls, the glue trap 10 rolls and covers the rodent 32. Continued motion by the rodent 32 causes the glue trap 10 to completely cover the rodent 32 and hide the rodent 32 from view. The glue trap 10 and the rodent 32 may be disposed of in a convenient manner.

FIG. 1 shows the indentations or score lines 18, 20, 22, 24, 26, 28 formed in a generally parallel array.

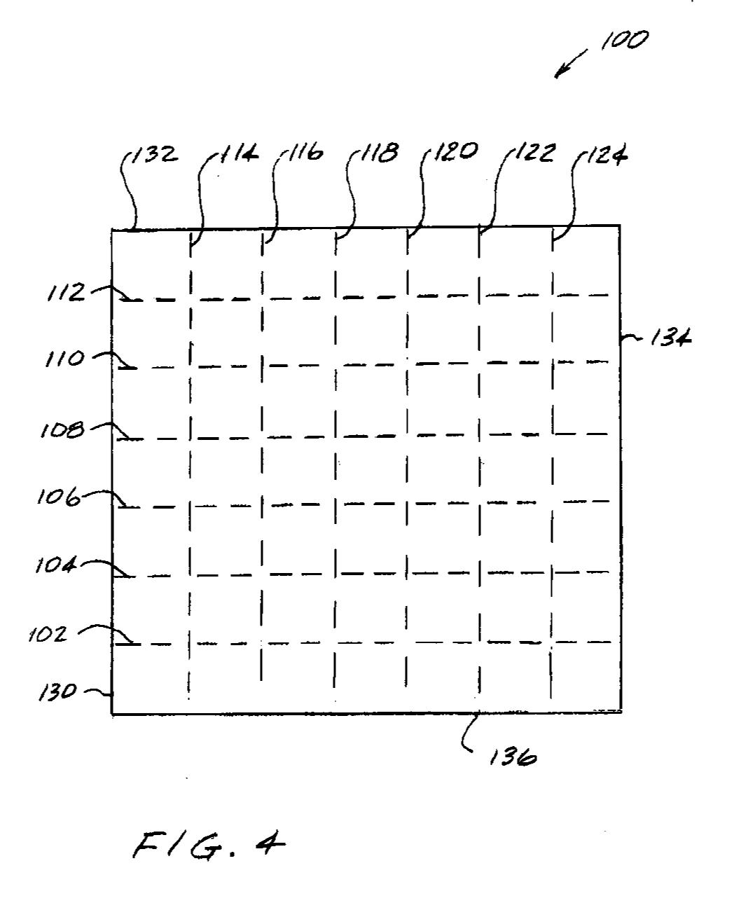

FIG. 4 shows an alternate embodiment 100 in which the indentations on score lines 102, 104, 106, 108, 110, 112, 114, 116, 118, 120, 122, 124 generally formed as a checkerboard or matrix array.

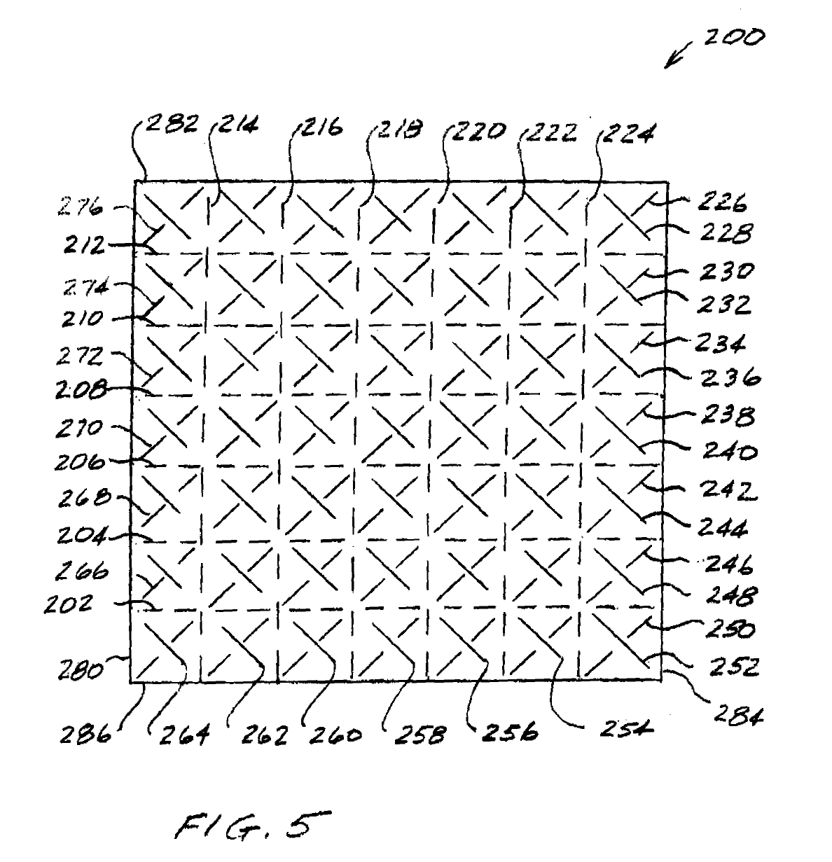

FIG. 5 shows another alternate embodiment in which the indentations on score lines 200, 202, 204, 206, 208, 210, 212, 214, 216, 218, 220, 222, 224, 226, 228, 230, 232, 234, 236, 238, 240, 242, 244, 246, 248, 250, 252, 254, 256, 258, 260, 262, 264, 266, 268, 270, 272, 274, 276 generally are formed as a checkerboard array combined with a cris-cross array. The embodiment of FIG. 5 provides a substrate with flexibility in all directions.

The glue traps 10, 100 and 200 have generally square configurations with edges 50, 52, 54, 56, 128, 130, 132, 134, 280, 282, 284, 286. It should be understood that rectangular, triangular, circular, oblong, curved or irregular configurations of the glue trap may be utilized.

The foregoing specific embodiment of the present invention as set forth in the specification herein is for illustrative purposes only. Various deviations and modifications may be made within the spirit and scope of this invention, without departing from a main theme thereof.

What is claimed is:

1. A self closing glue trap comprising:
a substrate having a first surface and a second surface;
a glue layer deposited on said first surface, and
a plurality of hinge portions formed on said second surface.

2. The self closing glue trap as claimed in claim 1 wherein said substrate comprises:
a cardboard substrate.

3. The self closing glue trap as claimed in claim 1 wherein said substrate comprises:
a pasteboard substrate.

4. The self closing glue trap as claimed in claim 1 wherein said substrate comprises:
a plastic substrate.

5. A self closing glue trap comprising:
a substrate having a first surface and a second surface;
a glue layer deposited on said first surface, and
a plurality of scored portions formed in said second surface.
